(19) United States
(12) Patent Application Publication
(10) Pub. No.: US 2019/0015897 A1
(43) Pub. Date: Jan. 17, 2019

(54) METHOD FOR PRODUCING A CREEP RESISTANT MATERIAL

(71) Applicant: Rolls-Royce Deutschland Ltd & Co KG, Blankenfelde-Mahlow (DE)

(72) Inventors: Dan ROTH-FAGARASEANU, Stahnsdorf (DE); Enrico DAENICKE, Berlin (DE)

(21) Appl. No.: 16/032,507

(22) Filed: Jul. 11, 2018

(30) Foreign Application Priority Data
Jul. 13, 2017 (DE) 10 2017 115 784.0

(51) Int. Cl. B22F 1/00; B22F 3/11; B29B 9/12

(52) U.S. Cl. CPC B22F 1/0022; B22F 1/0059; B22F 2998/10; B29B 9/12; B22F 3/1143

(57) ABSTRACT

Embodiments of the invention relate to processes for the production of a creep-resistant material. One of the processes provides the following: provision of a metal powder; provision of metallic or ceramic nanoparticles; mixing of the metal powder with the nanoparticles, where during the mixing procedure the particles of the metal powder and the nanoparticles neither change their size nor change their shape; and consolidation of the mixture of metal powder and of nanoparticles to form a material with a polycrystalline metal structure, where the individual grains which have resulted from the consolidation and which are part of the polycrystalline metal structure have been produced from the particles of the metal powder and are separated from one another by grain boundaries, and where the arrangement has the nanoparticles at the grain boundaries.

### REFERENCE TO RELATED APPLICATION

This application claims priority to German Patent Application No. 10 2017 115 784.0 filed on Jul. 13, 2017, the entirety of which is incorporated by reference herein.

### BACKGROUND

The invention relates to a method for producing a creep resistant material.

There is a general need for provision of creep-resistant materials. These materials are used by way of example in gas turbines, and in particular in aircraft engines. A known process for the production of creep-resistant materials consists in production of creep-resistant single crystals via casting followed by complex heat treatment.

There are moreover materials known as oxide-dispersion-strengthened (ODS) alloys. ODS alloys consist of a metal alloy in powder form with relatively low creep resistance and good formability, into which nanoscale oxides, for example, yttrium oxide, are incorporated by milling by way of mechanical alloying in a lengthy powder-milling process with high energy cost. The mechanically alloyed powder is compacted in simple geometric form by way of pressing and sintering, and is then subjected to downstream operations to give the final component. The abovementioned process is not only complicated and expensive but also brings with it the risk of introducing impurities.

EP 1 313 581 B1 discloses a process for the production of composite components via powder injection molding. It uses metal-composite powders comprising two or more different metals. In an embodiment, oxidic ceramic components, which can also take the form of nanopowders, are added to the metal-composite powder. Before the composite powder is mixed with a binder, and before powder injection molding, a protective liquid is mixed therewith, and protects the composite powder from contact with oxygen. The product produced by the process is a composite component.

DE 10 2004 063 052 A1 describes a process for the production of a molybdenum-based nanocomposite material which comprises a large number of nanoparticles dispersed in a molybdenum-based metallic matrix. The nanocomposite material comprises a high proportion of nanoparticles in the range from 2 percent by volume to 20 percent by volume of the molybdenum-based nanocomposite material. Specifically, the process provides formation of the nanoparticles in situ via mechanofusion, mechanical alloying, cryogrinding or a combination thereof. DE 10 2004 063 052 A1 therefore provides a forming process for the provision of the nanoparticles and for the formation of a nanocomposite.

The abovementioned processes are complicated and expensive and/or restricted in their choice of material. There is a need for processes that provide creep-resistant materials in a simpler manner, in particular without mechanical alloying.

Accordingly, there is a need of providing processes which can produce creep-resistant materials while not requiring mechanical alloying.

### SUMMARY

According to an aspect of the invention a process is provided which comprises the following steps for the production of a creep-resistant material:
provision of a metal powder,
provision of metallic or ceramic nanoparticles,
mixing of the metal powder with the nanoparticles, where during the mixing procedure the particles of the metal powder and the nanoparticles neither change their size nor change their shape, and
consolidation of the mixture of metal powder and of nanoparticles to form a material with a polycrystalline metal structure, where
the individual grains which have resulted from the consolidation and which are part of the polycrystalline metal structure have been produced from the particles of the metal powder and are separated from one another by grain boundaries, and where the arrangement has the nanoparticles at the grain boundaries.

Accordingly, an aspect of the present invention provides a process for the production of a creep-resistant material which has a polycrystalline metal structure which results from the consolidation of a metal powder, where the individual grains which have resulted from the consolidation and which are part of the polycrystalline metal structure have been produced from the particles of the metal powder and are separated from one another by grain boundaries. At the grain boundaries there is a high concentration of the metallic or ceramic nanoparticles.

A feature of the process is that the mixing of the metal powder with the nanoparticles is achieved without any change in the size of, or in the shape of, the metal powder or of the nanoparticles. Because of this, the process is significantly simplified in comparison with known processes for the production of oxide-dispersion-strengthened (ODS) alloys. The invention is based here on the surprising discovery that sufficient arrangement of the nanoparticles at the surfaces of the particles of the metal powder is achieved by the simple mixing (without any comminution) of metal powder and of nanoparticles, in a manner such that after consolidation of the powder mixture the nanoparticles are then present at the grain boundaries of the individual grains of the polycrystalline metal structure produced during the consolidation procedure, and thus increase the creep resistance of the material.

In the polycrystalline metal structure produced by the process of the invention, the nanoparticles are present exclusively at the grain boundaries. The nanoparticles here do not form a nanocomposite, i.e. they have not been incorporated as lattice points into the metal lattice, and have not been produced via a forming process.

The above is based on the fact that particles arranged at the grain boundaries prevent grain boundary sliding at high temperatures under load. To a certain extent, the particles located at the grain boundaries fix the individual grains to one another and/or reduce their susceptibility to displacement. The creep resistance of the material is thus improved. The invention therefore provides a creep-resistant material.

The statement that during the mixing step of the process the particles of the metal powder and the nanoparticles neither change their size nor change their shape means in particular that the typically spherical metal powder particles retain their spherical shape during the mixing procedure. The statement that during the mixing step of the process the particles of the metal powder and the nanoparticles neither change their size nor change their shape means moreover that no nanoparticles are produced during the mixing procedure. Instead, these are provided as starting material for the process.

The expression polycrystalline metal structure means a crystalline metal structure which consists of individual grains separated from one another by grain boundaries. The individual grains here have been produced by the consolidation of the metal powder, and correspond to the strengthened metal particles of the metal powder.

An embodiment of the invention provides that the mixing of the metal powder with the nanoparticles is achieved via grinding in a mill, where the nanoparticles arrange themselves at the surfaces of the particles of the metal powder during the mixing procedure, and where the grinding time, the nature of the mill and the size of the particles of the metal powder and of the nanoparticles are appropriate to one another in a manner such that during the grinding procedure the particles of the metal powder and the nanoparticles neither change their size nor change their shape. The mill is by way of example a planetary ball mill. Steel balls are an example of a grinding element used.

The grinding time is by way of example in the range from 5 min to 30 min, in particular in the range from 10 min to 20 min. The grinding time here is therefore relatively short, and does not have the effect of deforming and/or comminuting the particles.

In a variant, the mixing of the metal powder with the nanoparticles is achieved via grinding under a protective inert gas atmosphere, for example in an argon atmosphere.

Another variant provides that the mixing step takes place with use of a grinding aid that increases the adhesion of the nanoparticles at the metal surface. These grinding aids are known per se and typically improve the wettability of the surfaces and/or reduce the risk of clumping. The grinding aid is by way of example one based on polysaccharide.

An alternative embodiment provides that the mixing step comprises the mixing of the metal powder and of the nanoparticles in an aqueous suspension. It is possible here that the nanoparticles are provided in the aqueous suspension. Alternatively, the liquid is added to the metal particles and the nanoparticles.

The mixing of the metal powder and of the nanoparticles in an aqueous suspension can by way of example be ultrasound-assisted. It is moreover possible that after the mixing procedure the aqueous suspension is dried, where during the drying of the aqueous suspension the nanoparticles become distributed on the surfaces of the particles of the metal powder. However, the drying is merely optional. If by way of example consolidation is achieved via metal powder injection molding, it is alternatively possible that the mixed aqueous suspension is mixed with a binder without prior drying.

In an embodiment of the invention, the mixture of metal powder and of nanoparticles is consolidated by metal powder injection molding. The metal powder injection molding takes place in a manner known per se and comprises the following steps: provision of an injection-moldable metal powder mixture, injection molding of the injection-moldable metal powder mixture with an injection-molding machine, removal of binder from the resultant green body, thus producing a brown body corresponding to the component, and sintering of the brown body.

Consolidation via metal powder injection molding is, however, merely one embodiment. In principle, various processes can be used to consolidate the mixture of metal powder and of nanoparticles and to provide a desired shape thereto. Possible alternative processes are hot isostatic pressing and selective laser melting.

Another aspect of the invention provides a process for the production of a component made of a creep-resistant alloy where the following are mixed to give an injection-moldable metal powder mixture: a suspension with nanoparticles having a smaller average diameter than the metal particles of the metal powder, a binder, and a metal powder made of metal particles. The injection-moldable metal powder mixture thus produced is then used in an injection-molding process in which the metal powder mixture is consolidated and is molded to give the component made of a creep-resistant alloy. During the consolidation procedure, the nanoparticles of the metal powder mixture become bound at the grain boundaries of the polycrystalline metal structure that is produced during the consolidation of the metal powder mixture.

Accordingly, this aspect of the invention is based on the idea of improving a metal powder injection molding process (also termed MIM process (MIM=Metal Injection Molding)) in respect of the creep resistance of the sintered component, in that the injection-moldable metal powder mixture (also termed “feedstock”) which forms the starting point of the metal powder injection molding process is enriched with nanoparticles.

This aspect of the invention is based on the discovery that the nanoparticles that are admixed with the additional suspension of the feedstock remain in the material during removal of the binder and/or during sintering, and become bound in finely dispersed form on the grain boundaries of the material. Because they become bound on the grain boundaries, they prevent grain boundary sliding at high temperatures under load. The creep resistance of the material is thus improved.

It has been found here that the introduction of the nanoparticles into a suspension can prevent agglomeration of the nanoparticles and thus permit substantially homogeneous dispersion of the nanoparticles in the feedstock.

The actual metal powder injection molding process takes place in a manner known per se and comprises the following steps:
provision of an injection-moldable metal powder mixture,
injection molding of the injection-moldable metal powder mixture with an injection-molding machine;
removal of binder from the resultant green body, thus producing a brown body of the component, and
sintering of the brown body.

The powder mixture cooled here after injection molding forms a green body of the component. After removal from the injection-molding machine, binder is removed from the resultant green body, thus producing a brown body. During sintering, the component undergoes a shrinkage process. The result is a highly creep-resistant material in which the creep resistance at the grain boundaries has been increased by way of the nanoparticles introduced.

Another embodiment provides that the concentration of the nanoparticles in the mixture of the metal powder and of nanoparticles is in the range from 0.1 to 3 percent by mass, in particular in the range from 0.2 to 1 percent by mass, in particular in the range from 0.3 to 0.7 percent by mass. Examples of the concentration of the nanoparticles in the mixture of metal powder and of nanoparticles are therefore 0.5%, 1% and 3%.

In one variant, diameters of the nanoparticles are in the range from 10 nm to 5 μm, and particularly in the range from 10 nm to 1 μm, in particular in the range from 300 nm to 700 nm. By way of example, diameters of the particles of the metal powder, or diameters of individual crystals of the material, are in the range from 20 μm to 300 μm (D100=300 μm). This means that the particles or individual grains have a size distribution that is within the abovementioned ranges but does not necessarily encompass the entirety of said ranges. It is possible by way of example that the size of all of the nanoparticles is approximately identical, the sieve size of these being by way of example from 20 nm to 80 nm.

The sieve size is defined via the unit “mesh”. “Mesh” is a unit of mesh width. At the same time, “mesh” also indicates the grain size of correspondingly sieved material. The largest and the smallest sieve size therefore provides the largest and the smallest grain sizes of a mixture. The arithmetic average of the grain sizes, on the other hand, provides the average diameter.

Another variable that can be used to characterize particle mixtures is the D factor. This is the diameter that divides the weight of the mixture into defined percentage proportions when all of the particles of a mixture have been placed in order of increasing mass. The D30 factor is therefore the diameter at which 30% of the weight of the mixture is provided by smaller particles and 70% of the weight of the mixture is provided by larger particles. In an embodiment of the invention, the D50 factor of the nanoparticles is in the range from 10 nm to 100 nm, in particular in the range from 40 nm to 80 nm, i.e. 50% of all of the nanoparticles are smaller than this value.

One embodiment provides that the D90 factor of the nanoparticles is smaller than or equal to 2 μm and their D50 factor is smaller than or equal to 500 nm.

In an embodiment, the D50 factor of the metal powder particles is in the range from 10 μm to 40 μm. By way of example, in an embodiment the D10 factor is from 5 to 7 μm, in particular 6 μm, the D50 factor is from 16 to 20 μm, in particular 18 μm, and the D90 factor is from 30 to 40 μm, in particular 35 μm.

The nanoparticles used can be metallic particles or ceramic particles. Embodiments of the invention provide that the nanoparticles are oxides, in particular ceramic oxides. They then form an oxide powder. Examples of suitable nanoparticles are yttrium oxide, aluminum oxide and zirconium oxide. By way of example, aluminum oxide with the tradename Alumina CT3000 LS SG sold by Almatis can be used.

It is moreover possible that the specific surface area of the metal powder particles is in the range from 0.05 m²/g to 0.2 m²/g.

In an embodiment of the invention, nickel-based alloys and/or cobalt-based alloys are used as metal powder. An alloy therefore forms the metal powder, i.e. each of the metal particles. Accordingly, the material produced by the process of the invention is a creep-resistant alloy. Examples of alloys used are high-specification nickel-based alloys termed Inconel 713, Inconel 738, CM247 and MAR M247, C263 and C1023.

Insofar as in one of the variants of the invention a metal powder made of metal particles is mixed with a binder and with a suspension comprising nanoparticles to give an injection-moldable metal powder mixture, an embodiment provides that nanoscale metallic particles are admixed with the suspension and form ceramic particles during the sintering procedure. By way of example, aluminum particles are used as nanoscale particles and after oxidation form ceramic Al₂O₃.

There are various ways of achieving the homogeneous mixing of the suspension comprising the nanoparticles with the other components of the feedstock. In a first variant, the suspension is mixed with the metal powder and this mixture is then mixed with the binder to give an injection-moldable metal powder mixture. An advantage of this variant is that, even before mixing with the binder, the nanoparticles can place themselves preferentially onto the grain boundaries of the metal particles. It is possible here that, before mixing with the binder, the mixture of suspension and metal powder is dried in order to evaporate the dispersion medium before mixing with the binder.

A second variant provides that the suspension is mixed with the binder and that this mixture is then mixed with the metal powder to give an injection-moldable metal powder mixture. In this variant, the nanoparticles are preferentially present in the binder. In the green body, the binder is present in the interstices between the metal particles. During binder removal, which can be achieved chemically or thermally, the nanoparticles remain in the interstices. When the interstices between the metal particles disappear during sintering, they then automatically become bound at the grain boundaries of the metal particles.

In a third variant, the suspension, the metal powder and the binder are simultaneously mixed to give an injection-moldable metal powder mixture.

Insofar as in one of the variants of the invention a metal powder made of metal particles is mixed with a binder and with a suspension comprising nanoparticles to give an injection-moldable metal powder mixture, an embodiment provides that the proportion by volume of the binder is from 30-50 percent by volume. Accordingly, the proportion by volume of the metal powder is about 50-70 percent by volume—if the proportion by volume of the suspension or of the nanoparticles is ignored.

The metal powder can in principle be any injection-moldable metal powder. In an embodiment, the metal particle comprises nickel- and/or cobalt-based alloys. Examples of these are, as mentioned above, the alloys C1023, C263, CM247, Inconel 713 and Inconel 738. The D100 factor of the metal powder is by way of example in the range from 30 μm to 300 μm. The D50 factor is by way of example in the range from 15 μm to 50 μm. In each case, the average grain size of the metal powder is larger than the average grain size of the nanoparticles, in particular by at least a factor of 10, in particular by at least a factor of 100.

The binder system for the feedstock can consist of various polymers. Examples of materials used are polyamides, wax and/or polyoxymethylene (POM), and in some variants also additions that promote wetting. By way of example, a binder consisting of a mixture of wax and POM is used.

Another embodiment of the invention provides that the nanoparticles consist of a material different from that of the metal particles of the metal powder. This will almost always be the case.

Another aspect of the invention provides a creep-resistant material characterized in that it has been produced via the process as claimed in claim 1 or the process as claimed in claim 9. The creep-resistant material has a polycrystalline metal structure which results from the consolidation of a metal powder, where the individual grains which have resulted from the consolidation and which are part of the polycrystalline metal structure have been produced from the particles of the metal powder and are separated from one another by grain boundaries. At the grain boundaries there is a high concentration of the metallic or ceramic nanoparticles.

In preferred embodiments of the invention, the process of the invention is used to produce a component of a gas turbine, in particular of an aircraft engine. Examples of applications are found in the production of components of the combustion chamber or of the turbine of a gas turbine.

### BRIEF DESCRIPTION OF THE DRAWINGS

The invention will be explained in more detail on the basis of exemplary embodiments with reference to the accompanying drawings in which:

FIG. 1 shows the fundamental sequence of a first process of the production of a polycrystalline material via metal powder injection molding with use of a suspension with nanoparticles;

FIG. 2a is a diagram of the steps in the sequence of a first variant for the production of the feedstock;

FIG. 2b is a diagram of the steps in the sequence of a second variant for the production of the feedstock;

FIG. 2c is a diagram of the steps in the sequence of a third variant for the production of the feedstock;

FIG. 3a shows the fundamental sequence of a second process for the production of a polycrystalline material;

FIG. 3b shows a variant of the process of FIG. 3a;

FIG. 4 is a diagram of the structure of a polycrystalline material produced according to a process as in FIG. 1, 3a or 3b after sintering, depicting individual crystals and nanoparticles bound at the grain boundaries of the individual grains.

### DETAILED DESCRIPTION

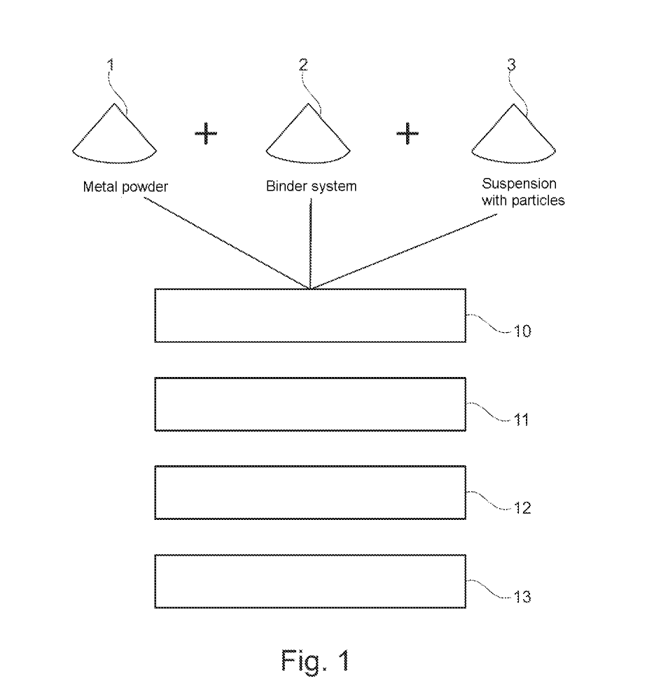

FIG. 1 is a diagram of a process for the production of a component made of a polycrystalline material via metal powder injection molding, where the creep resistance of the material is improved by adding nanoparticles.

In a first step 10, an injection-moldable metal powder mixture, the feedstock, is provided. To this end, three components are mixed together. The first component is a metal powder 1 made of metal particles. The second component is a binder system 2. The third component is a suspension 3 with nanoparticles.

The metal powder 1 is typically an alloy. For high-temperature applications, nickel- and cobalt-based alloys are in particular used. Examples of these are the super alloys C1023, CM247, Inconel 713, Inconel 738. The average grain size of the particles is by way of example in the range from 30 μm to 300 μm.

The binder system 2 can consist of polymers. Examples of polymers used are polyamides, wax and/or polyoxymethylene (POM). Additions that promote wetting can also be added.

For the metal powder 1 and the binder system 2 it is in principle possible to make use of metal powders and binder systems of the type disclosed in the prior art.

The suspension 3 comprises ceramic particles, in particular oxides, for example yttrium oxide, aluminum oxide or zirconium oxide. Alternative variants can use metallic particles. The particles are nanoparticles. For the purposes of the invention, this does not exclude the possibility that they comprise grain sizes extending into the micrometer range: the sieve size of the ceramic particles by way of example being from 10 nm to 5 micrometers. In other embodiments, the sieve sizes are in the range from 10 nm to 1 μm or in the range from 20 nm to 100 nm.

In an embodiment, the size of the ceramic nanoparticles is in the range from 60 to 80 nm. This is the D50 factor, and therefore 50% of all of the particles have a size smaller than this value. It is also possible to use larger particles to increase creep resistance at the grain boundaries: possible sizes are the ceramic particles being from a few hundred nanometers up to a few micrometers (from 100 nm to 5 μm).

The nanoparticles are wetted in the suspension, and agglomeration of the nanoparticles is thus prevented or at least significantly reduced. A suspension involves introduction of the particles into a solution (the dispersion medium) that wets the surface of the particles and thus inhibits agglomeration (“clumping”). The solution generally consists of a liquid which by way of example can be ethanol, water or glycerol. The liquid content of the suspension is not necessarily a single substance, but can instead itself be a mixture. The carrier liquid can therefore be a solution, an emulsion or an unsedimented dispersion. These suspensions are prior art and can be produced in accordance with the requirements of the particular nanopowder. The suspension is mixed together with the other constituents of the feedstock (binder and metal powder) in a manner that gives homogeneous dispersion of the suspension and therefore of the ceramic particles into the resultant feedstock. The mixing can be carried out mechanically (at room temperature or elevated temperature) as required by the composition of the feedstock. An elevated temperature reduces the viscosity of the binder, and can therefore have a favorable effect on the mixing procedure in terms of homogeneity.

The mixing ratio of ceramic particles of the suspension 3 to the metal powder 1 is by way of example in the range from 0.25 percent by mass to 1 percent by mass. Particles made of a nickel-based alloy are by way of example used as metal powder with this mixing ratio.

The mixing ratio of binder system 2 to metal powder 1 in principle reflects the prior art and is typically from 50 to 70% by volume of metal powder and from 30 to 50 percent by volume of binder. Resultant proportions by mass are about 90-95% of metal powder and 5-10% of binder, depending on the alloy and binder system used.

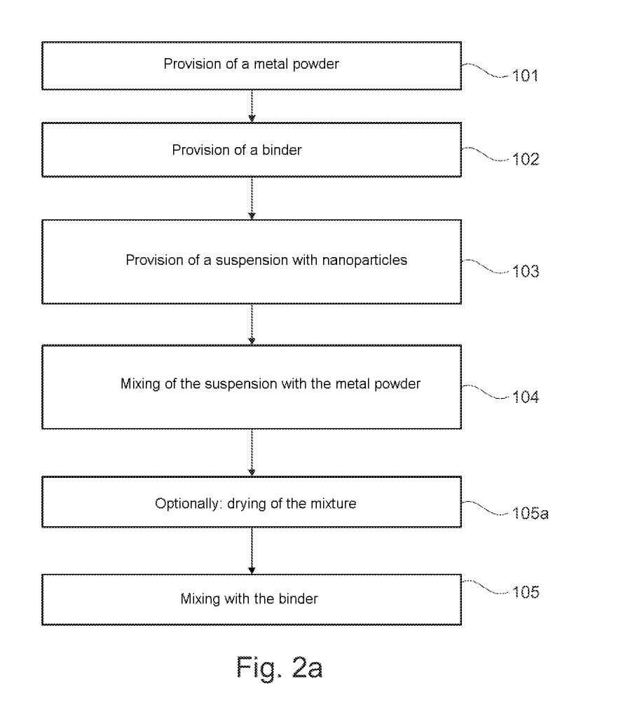

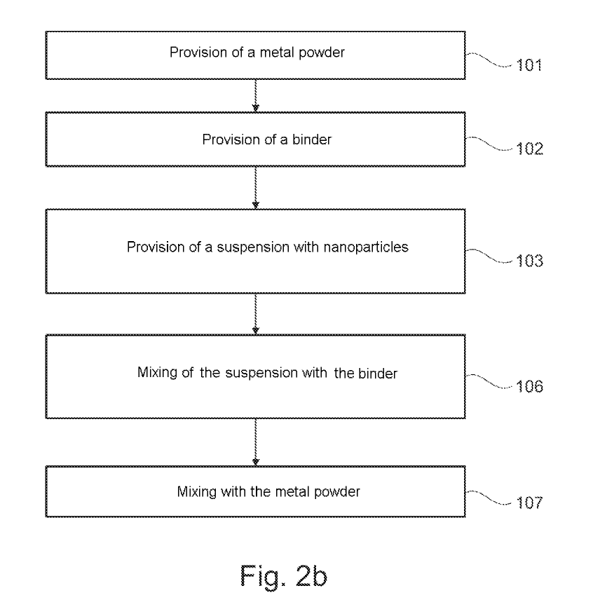

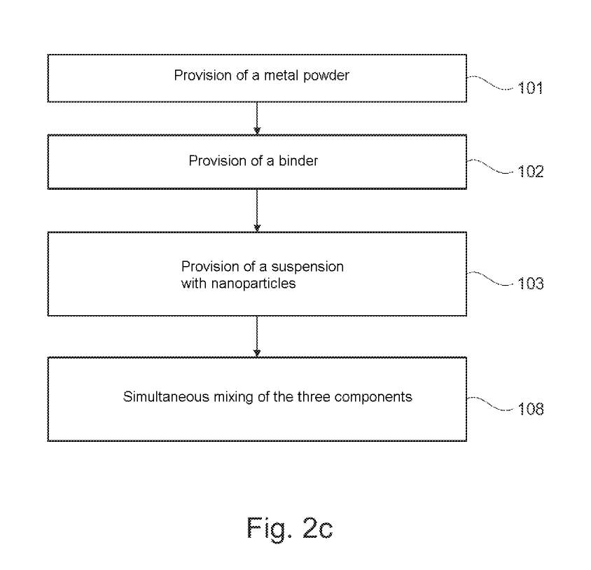

Various variants of a process for the homogeneous mixing of the three components metal powder 1, binder system 2 and suspension 3, are described with reference to FIGS. 2a to 2c. In FIG. 2a, the metal powder 1, the binder 2 and the suspension 3 with nanoparticles are first provided, as discussed above, in the steps 101, 102, 103. The suspension 3 comprising the nanoparticles is then mixed with the metal powder 1 in step 104. Nanoparticles become bound at the grain boundaries of the metal particles of the metal powder 3 here. This is followed in step 105 by homogeneous mixing with the binder. It is possible here, in a variant, that before mixing with the binder in the optional step 105a the mixture of suspension 3 with the metal powder 1 is dried in order to evaporate the dispersion medium before mixing with the binder.

In the process variant of FIG. 2b, the metal powder 1, the binder 2 and the suspension 3 with nanoparticles are again first provided in the steps 101, 102, 103. In step 106, the suspension 3 with the nanoparticles is then mixed with the binder 2. In the step 107, the mixture is then mixed homogeneously with the metal powder. In this process variant, the nanoparticles have already become bound to a relatively small extent at the grain boundaries of the metal particles of the metal powder 3 in the feedstock.

In the process variant of FIG. 2c, the metal powder 1, the binder 2 and the suspension 3 with nanoparticles are again first provided in the steps 101, 102, 103. In step 108, the metal powder 1, the binder system 2 and the suspension 3 with nanoparticles are then simultaneously mixed homogeneously.

With reference again to FIG. 1, a metal powder injection molding process follows after production of the feedstock in the step 10. The precise process parameters here depend on the feedstock constituents, in particular on the materials used and the mixing ratio of metal powder 1 and binder system 2. In the step 11, the feedstock is injected into a cavity of an injection mold. After the injection-molding process, the resultant workpiece is removed from the cavity (this procedure being known as demolding). The cooled feedstock forms a green body of the required component.

In the subsequent step 12, binder is removed from the resultant green body. The process of binder removal from the green body can take place in a manner known per se. In particular, the binder can be removed by a chemical dissolution procedure and/or can be driven off by heating. A brown body of the required component is thus produced. It is important for the invention here that the nanoparticles remain at least to some extent in the green body during the binder-removal process: without any requirement for particular measures to achieve this, the nanoparticles have become bound at the grain boundaries in the green body and/or remain in the interstices still present in the green body between the grains or particles of the metal powder.

In the step 13, the brown body is sintered. This is typically achieved at temperatures in the range from 1100° C. to 1300° C. The sintering process is attended by shrinkage of the component to a certain extent.

In contrast to standard ODS alloys (e.g. PM1000, PM2000), where mechanical alloying is used to introduce the ceramic nanoparticles into the grain, and the distance between said particles in the product is usually about 100-200 nm, the present invention preferably uses alloys that already have good creep properties because, within the grain, they have a phase providing a high degree of strengthening. Introduction of ceramic particles at the grain boundaries further increases the creep resistance by inhibiting grain-boundary sliding and grain-boundary diffusion processes. Alloys that can be used are by way of example high-specification nickel-based alloys such as: Inconel 713, Inconel 738, CM247 and MAR M247, C263, C1023.

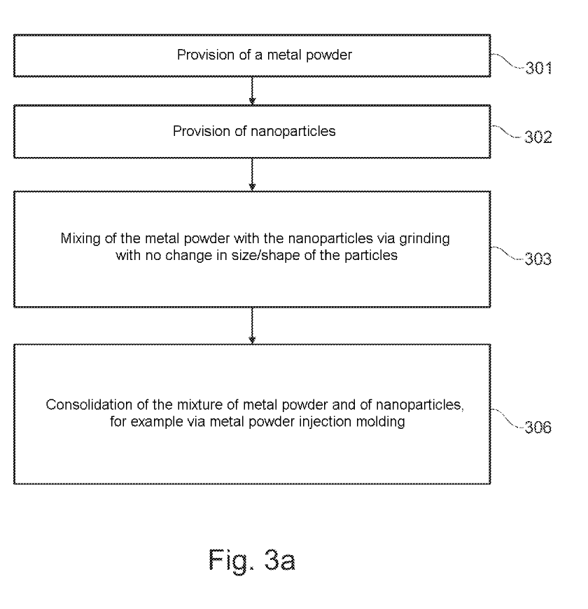

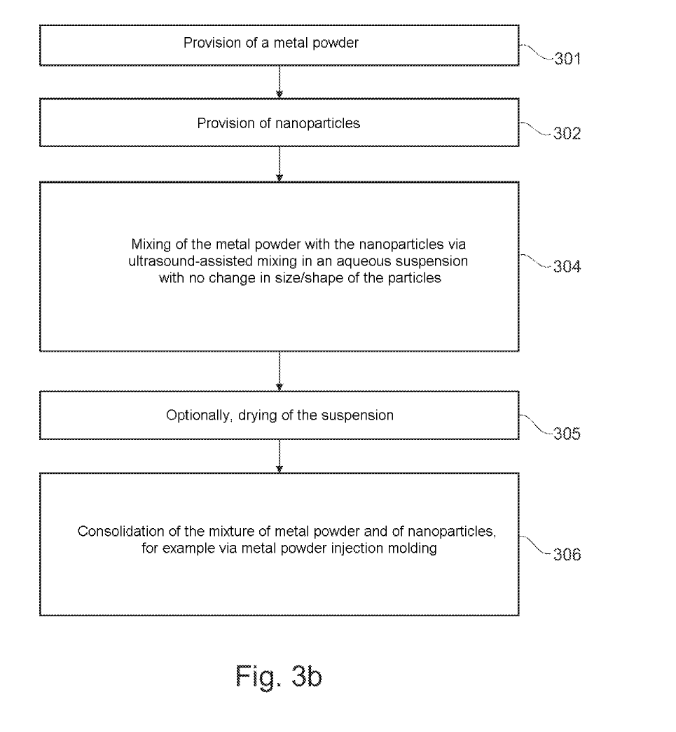

FIG. 3a shows another process for the production of a creep-resistant material. The starting point of the process in FIG. 3a involves only two components, firstly a metal powder made of metal particles and secondly metallic or ceramic nanoparticles.

In the steps 301 and 302, a metal powder and a quantity of nanoparticles are provided. The statements made in relation to FIGS. 1 to 2c apply correspondingly in respect of the sizes and size distributions of metal powder and of nanoparticles: in a variant it is possible that high-specification nickel-based alloys are used as metal powder, examples being Inconel 713, Inconel 738, CM247 and MAR M247, C263, C1023. The D50 factor of the metal powder is by way of example in the range from 10 μm to 40 μm.

In a specific embodiment, the D50 factor of the particles of the metal powder is 18 μm, the D10 factor is 6 μm and the D90 factor is 35 μm. The specific surface area of the particles of the metal powder in the specific embodiment is 0.1 m²/g.

The nanoparticles consist by way of example of yttrium oxide, aluminum oxide or zirconium oxide. The D50 factor is by way of example in the range from 30 nm to 500 nm. The specific embodiment mentioned, as nanoparticles, the aluminum oxide sold with tradename Alumina CT3000 LS SG from Almatis, or another aluminum oxide. The D50 factor of the aluminum oxide is 500 nm, and the D90 factor is 2 μm.

In step 303, the metal powder is mixed with the nanoparticles by grinding. The grinding procedure takes place in a mill which by way of example is configured as planetary ball mill with grinding balls made of steel. In an embodiment here, the grinding procedure takes place in a protective atmosphere, for example of argon. A grinding aid that increases the adhesion of the nanoparticles at the metal surface can be added to the mixture of metal powder and nanoparticles. The grinding aid is by way of example based on polysaccharides.

The concentration of the nanoparticles in the mixture of metal powder and nanoparticles in embodiments is 0.5 percent by mass, 1 percent by mass or 3 percent by mass.

The grinding time is selected appropriately for the size of the metal particles and the nature of the mill in a manner such that during the grinding procedure the particles of the metal powder and the nanoparticles neither change their size nor change their shape. Accordingly, the grinding procedure takes place for a relatively short period, for example for a period of from 10 to 20 minutes, for example 15 minutes.

By virtue of the relatively short grinding time, the spherical metal particles retain a spherical shape after the grinding procedure, whereas this is not the case after mechanical alloying. The nanoparticles have not been incorporated into the metal particles, but instead have merely placed themselves at the surface of the metal particles. The grinding aid here improves the adhesion of the nanoparticles at the surface of the metal particles.

Once the particles of the metal powder and the nanoparticles have been mixed with one another in the step 303 in a manner such that the nanoparticles have become arranged at the surfaces of the particles of the metal powder, consolidation of the mixture of metal powder and nanoparticles then takes place in step 306 to form a material with a polycrystalline metal structure. The consolidation is achieved by way of example by way of metal powder injection molding. As explained with reference to FIGS. 1 to 2c, an injection-moldable metal powder mixture is obtained here by admixing a binder with the powder mixture produced in the step 303, and this is followed by injection molding of the injection-moldable metal powder mixture in an injection mold, removal of binder from the resultant green body with formation of a brown body, and sintering of the brown body. However, other consolidation processes can also be used, for example consolidation by way of hot isostatic pressing or selective laser melting.

FIG. 3b shows a modified version of FIG. 3a which differs in the steps 304 and 305 from the process of FIG. 3a: in the embodiment of FIG. 3b, the step of mixing of the metal powder with the nanoparticles is implemented in an aqueous suspension. It is possible here that in step 302 the nanoparticles are already provided in the suspension, as in step 103 of FIG. 2a.

The mixing procedure can be ultrasound-assisted. The mixed aqueous suspension is then dried in the optional step 305, thus giving agglomeration-free distribution of the nanoparticles on the metal particles.

The resultant particle mixture is then mixed with a binder in order to provide an injection-moldable metal powder mixture. Alternatively, drying of the aqueous suspension is omitted, and in this case said suspension is immediately mixed with a binder. The optional step 305 is omitted here.

The further consolidation steps take place as described with reference to FIG. 3a. Alternative consolidation processes can also be used.

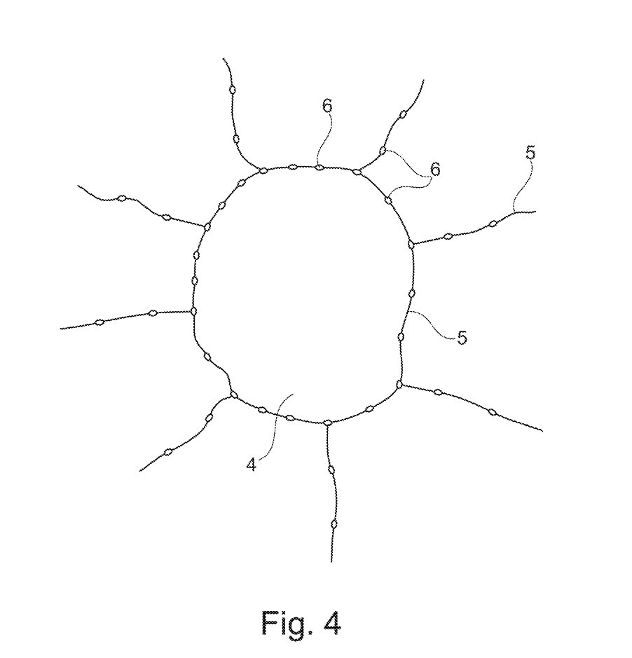

FIG. 4 is a diagram for the structural units of a creep-resistant alloy with a polycrystalline metal structure produced in a process as in FIG. 1, as in FIG. 3a or as in FIG. 3b. The alloy comprises individual crystals 4 (also termed grains), respectively produced during sintering from a particle of the metal powder 1. Associated with the individual crystals 4 depicted there are other individual crystals. Grain boundaries 5 separate the individual crystal or the grains 4 from one another, these being structures deriving from the original separate nature of the metal particles before sintering. However, unlike in the case of the green body, there are no interstices between the individual crystals 4.

The nanoparticles 6 introduced into the feedstock by way of the suspension 3 (FIG. 1), or the nanoparticles placed onto the surface of the metal particles during the mixing of the powders (FIGS. 3a, 3b) have been retained and bound in finely dispersed form at the grain boundaries 5 of the individual crystals 4. The nanoparticles 6 bound at the grain boundaries 5 prevent slip between the grain boundaries 5 at high temperatures under load. To a certain degree, they stop relative movement between the individual crystals 4. The result is a highly creep-resistant material in which the creep resistance has been increased at the grain boundaries by way of the nanoparticles 6 introduced.

The present invention is not restricted to the embodiments described above, which are merely examples. By way of example, the materials specifically mentioned for the nanoparticles and for the metal powder are merely examples.

It is furthermore pointed out that the features of the individually described exemplary embodiments of the invention can be combined in various combinations with one another. Where areas are defined, they include all the values within these areas and all the sub-areas falling within an area.

What is claimed is:

1. A process for the production of a creep-resistant material with the following steps:
provision of a metal powder,
provision of metallic or ceramic nanoparticles,
mixing of the metal powder with the nanoparticles, where during the mixing procedure the particles of the metal powder and the nanoparticles neither change their size nor change their shape, and
consolidation of the mixture of metal powder and of nanoparticles to form a material with a polycrystalline metal structure, where
the individual grains which have resulted from the consolidation and which are part of the polycrystalline metal structure have been produced from the particles of the metal powder and are separated from one another by grain boundaries, and where the arrangement has the nanoparticles at the grain boundaries.

2. The process as claimed in claim 1, wherein the mixing of the metal powder with the nanoparticles is achieved via grinding in a mill, where the nanoparticles arrange themselves at the surfaces of the particles of the metal powder during the mixing procedure, and where the grinding time, the nature of the mill and the size of the particles of the metal powder and of the nanoparticles are appropriate to one another in a manner such that during the grinding procedure the particles of the metal powder and the nanoparticles neither change their size nor change their shape.

3. The process as claimed in claim 2, wherein the grinding time is in the range from 5 min to 30 min, in particular in the range from 10 min to 20 min.

4. The process as claimed in claim 1, wherein the mixing step takes place with use of a grinding aid that increases the adhesion of the nanoparticles at the metal surface.

5. The process as claimed in claim 1, wherein the mixing step comprises the mixing of the metal powder and of the nanoparticles in an aqueous suspension.

6. The process as claimed in claim 5, wherein the mixing of the metal powder and of the nanoparticles in an aqueous suspension is ultrasound-assisted.

7. The process as claimed in claim 6, wherein after the mixing procedure the aqueous suspension is dried, where during the drying of the aqueous suspension the nanoparticles become distributed on the surfaces of the particles of the metal powder.

8. The process as claimed in claim 1, wherein the mixture of metal powder and of nanoparticles is consolidated by metal powder injection molding.

9. A process for the production of a component made of a creep-resistant alloy, with the following steps:
provision of a metal powder,
provision of a binder,
provision of a suspension with metallic or ceramic nanoparticles, where the average diameter of the nanoparticles is smaller than that of the particles of the metal powder,
mixing of these three components to give an injection-moldable metal powder mixture, and
use of the metal powder mixture in an injection-molding process in which the metal powder mixture is consolidated and is molded to give the component made of a creep-resistant alloy,
where, during the consolidation of the metal powder mixture, the nanoparticles become bound at the grain boundaries of the polycrystalline metal structure that is produced during the consolidation of the metal powder mixture.

10. The process as claimed in claim 1, wherein the concentration of the nanoparticles in the mixture of metal powder and of nanoparticles is in the range from 0.1 to 3 percent by mass, in particular in the range from 0.2 to 1 percent by mass, in particular in the range from 0.3 to 0.7 percent by mass.

11. The process as claimed in claim 1, wherein the nanoparticles are oxides.

12. The process as claimed in claim 11, wherein the nanoparticles consist of yttrium oxide, aluminum oxide or zirconium oxide.

13. The process as claimed in claim 1, wherein the sieve sizes of the nanoparticles are in the range from 10 nm to 5 μm, and particularly in the range from 10 nm to 1 μm, in particular in the range from 300 nm to 700 nm.

14. The process as claimed in claim 1, wherein the D90 factor of the nanoparticles is smaller than or equal to 2 μm and their D50 factor is smaller than or equal to 500 nm.

15. The process as claimed in claim 1, wherein the D50 factor of the metal powder particles is in the range from 10 μm to 40 μm.

16. The process as claimed in claim 1, wherein the specific surface area of the metal powder particles is in the range from 0.05 m²/g to 0.2 m²/g.

17. The process as claimed in claim 1, wherein the particles of the metal powder comprise, or consist of, nickel-based and/or cobalt-based alloys.

18. The process as claimed in claim 9, wherein the suspension is mixed with the metal powder and this mixture is then mixed with the binder to give an injection-moldable metal powder mixture.

19. The process as claimed in claim 9, wherein the suspension, the metal powder and the binder are simultaneously mixed to give an injection-moldable metal powder mixture.

20. A creep-resistant material produced via a process as claimed in claim 1 or a process as claimed in claim 9.
